(19) United States
(12) Patent Application Publication
(10) Pub. No.: US 2015/0295649 A1
(43) Pub. Date: Oct. 15, 2015

(54) METHOD AND SYSTEM FOR PERFORMING FIBER NONLINEARITY COMPENSATION FOR OPTICAL 16QAM

(71) Applicant: Futurewei Technologies, Inc., Plano, TX (US)

(72) Inventors: Wei-Ren PENG, Sana Clara, CA (US); Fei ZHU, San Jose, CA (US); Yusheng BAI, Los Altos Hills, CA (US)

(21) Appl. No.: 14/682,717

(22) Filed: Apr. 9, 2015

Related U.S. Application Data
(60) Provisional application No. 61/978,678, filed on Apr. 11, 2014.

(51) Int. Cl. H04B 10/2543; H04L 27/34

(52) U.S. Cl. CPC H04B 10/2543; H04L 27/34

(57) ABSTRACT

A method for reducing link fiber nonlinearities executed by a processor. The method includes decomposing a high order quadrature amplitude modulation (QAM) input into a plurality of sub-components. The method includes applying a plurality of logical operations to the plurality of sub-components. The method includes determining a non-linear compensation term based on the applying the plurality of logical operations to the plurality of sub-components.

### CROSS REFERENCE TO RELATED APPLICATIONS

This application claims priority to and the benefit of U.S. Provisional Patent Application No. 61/978,678, filed on Apr. 11, 2014, entitled “Fiber Nonlinearity compensation for Optical 19QAM [sic],” the disclosure of which is hereby incorporated by reference in its entirety.

### BACKGROUND

In fiber optics communications, fiber nonlinearity is always a serious issue that limits the signal's reach/performance. In coherent optical communications, the signal reach and performance suffers the trade-off between linear and nonlinear distortion, i.e., at low transmitting power, the signal would sink into the linear noise while at high power, the signal phase would be strongly disturbed, and adversely affect the signal due to the fiber Kerr effect. Currently, many commercial optical systems utilize the polarization-division-multiplexing quadrature-phase-shift-keying (PDM-QPSK) format, which carries 4 bits/symbol per optical carrier. Facing the continuous increase in the demand for capacity, high quadrature amplitude modulation (QAM) formats, such as 16 QAM, have been developed. For instance, with the upgrade from PDM-QPSK to PDM-16 QAM, the bits/symbol per carrier could be increased from 4 to 8, thus doubling the capacity. However, the price of using 16 QAM is the reduced signal reach/performance due to its vulnerability against noise. While increasing the transmitting power may raise the signal to noise ratio, this unfortunately would also introduce significant nonlinear distortions that would compromise the signal.

It would be beneficial to reduce and/or overcome fiber nonlinearities to extend the reach of 16 QAM signaling.

### SUMMARY

In some embodiments of the present invention, an apparatus is disclosed for reducing link fiber nonlinearities. The apparatus includes memory having stored therein computer executable instructions, and a processor executing computer-executable instructions stored in the memory. The executable instructions include decomposing a high order QAM input into a plurality of sub-components. The instructions include applying a plurality of logical operations to the plurality of sub-components. The instructions include determining a non-linear compensation term based on the applying the plurality of logical operations to the plurality of sub-components.

In other embodiments, a method for reducing link fiber nonlinearities executed by a processor is disclosed. The method includes decomposing a high order QAM input into a plurality of sub-components. The method includes applying a plurality of logical operations to the plurality of sub-components. The method includes determining a non-linear compensation term based on the applying the plurality of logical operations to the plurality of sub-components.

In still other embodiments of the present invention, a system for reducing link fiber nonlinearities is disclosed. The system includes a communication network. The system includes a plurality of transmitters and a plurality of receivers coupled to the communication network, wherein at least one of a transmitter or a receiver is configured for reducing link fiber nonlinearities by decomposing a high order QAM input into a plurality of sub-components, applying a plurality of logical operations to the plurality of sub-components, and determining a non-linear compensation term based on the applying the plurality of logical operations to the plurality of sub-components.

These and other objects and advantages of the various embodiments of the present disclosure will be recognized by those of ordinary skill in the art after reading the following detailed description of the embodiments that are illustrated in the various drawing figures.

### BRIEF DESCRIPTION

The accompanying drawings, which are incorporated in and form a part of this specification and in which like numerals depict like elements, illustrate embodiments of the present disclosure and, together with the description, serve to explain the principles of the disclosure.

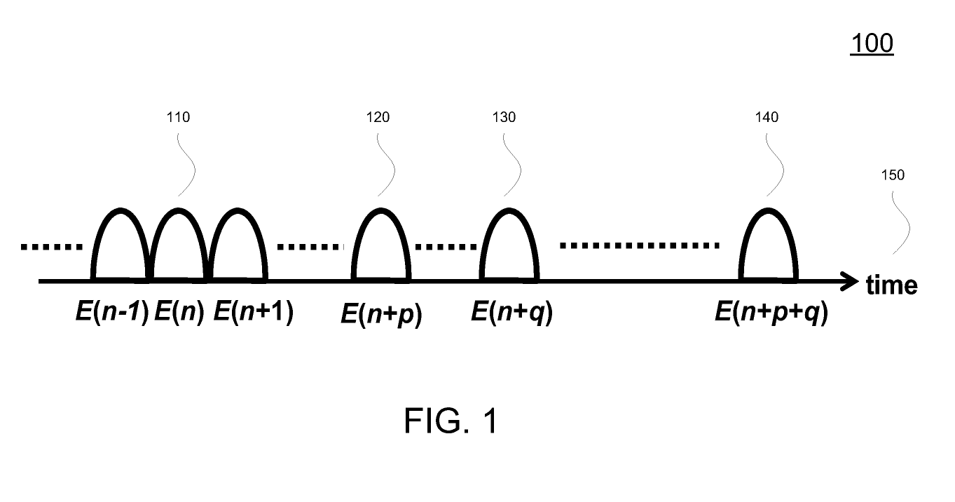

FIG. 1 depicts a diagram illustrating nonlinear terms in a model for fiber communications.

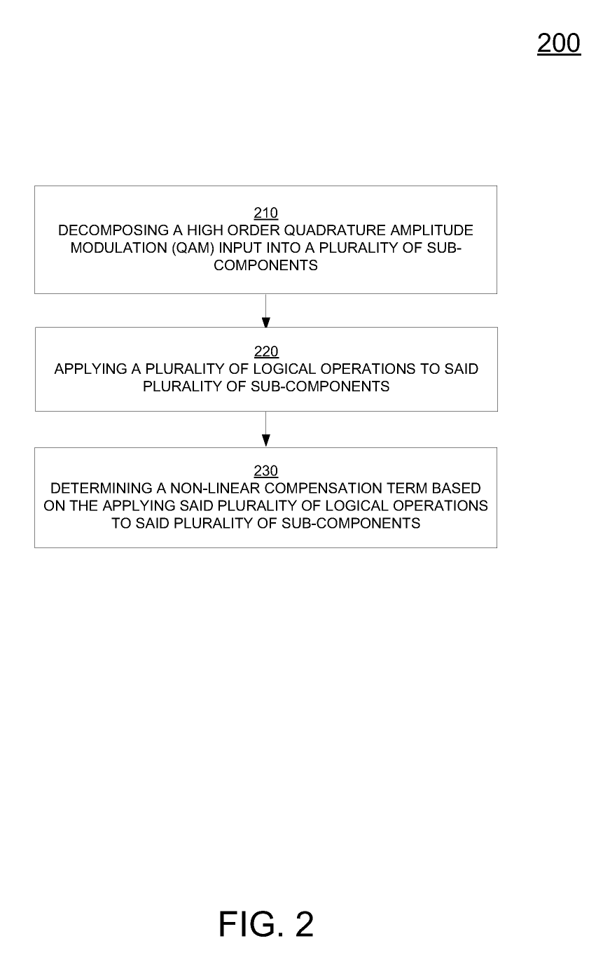

FIG. 2 depicts a flow diagram illustrating a method for reducing link fiber nonlinearities, in accordance with one embodiment of the present disclosure.

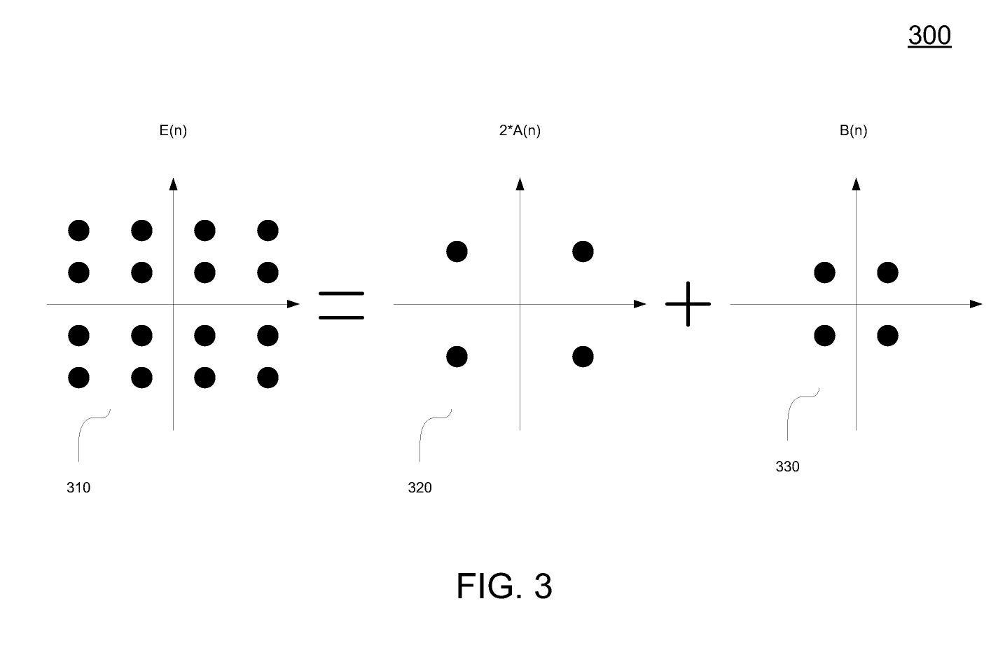

FIG. 3 depicts a diagram illustrating the decomposition of an input signal formatted in 16QAM into two QPSK symbols, in accordance with one embodiment of the present disclosure.

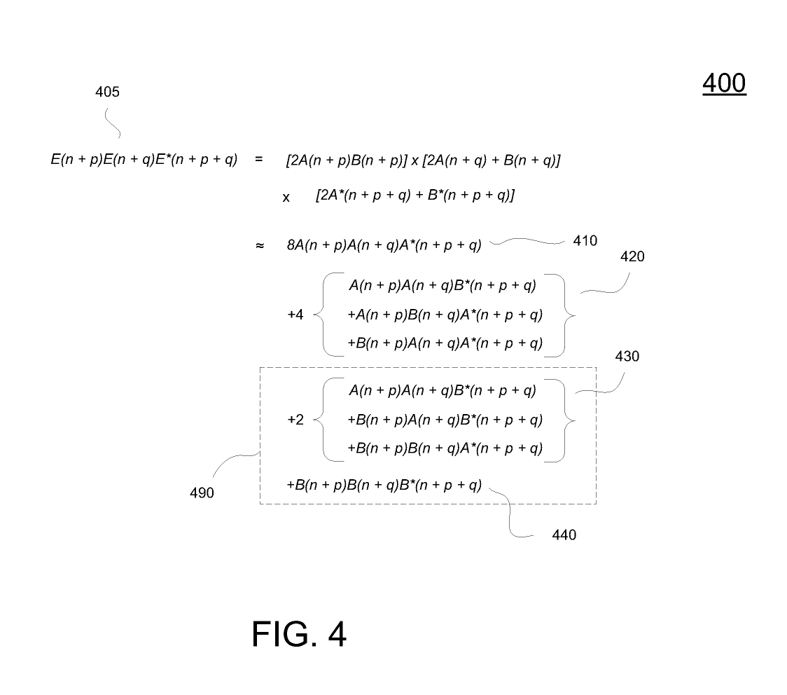

FIG. 4 depicts a diagram illustrating the expansion of a nonlinear term of an input signal modulated in QAM into QPSK symbols, in accordance with one embodiment of the present disclosure.

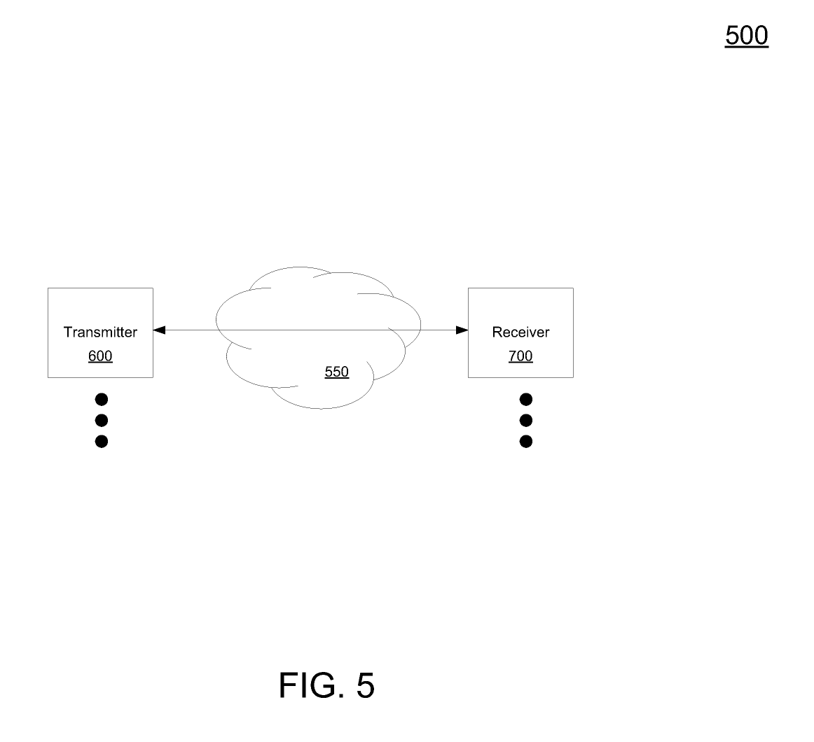

FIG. 5 depicts a system configured for reducing link fiber nonlinearities when sending and receiving signals formatted in QAM, in accordance with one embodiment of the present disclosure.

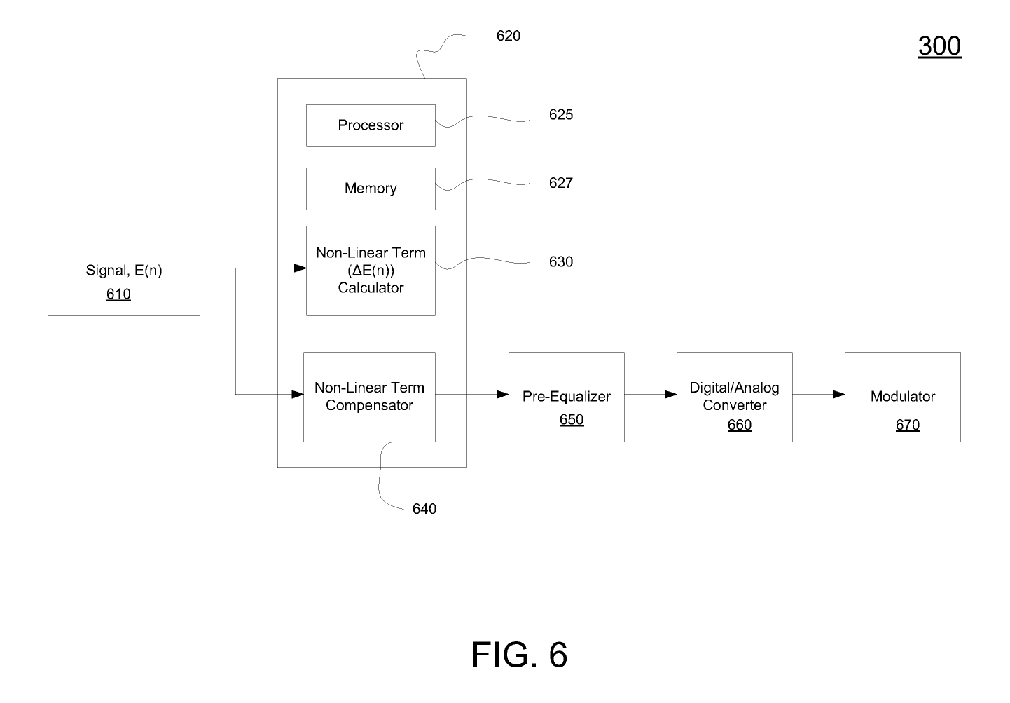

FIG. 6 depicts a transmitter configured for reducing link fiber nonlinearities when transmitting a signal formatted in QAM, in accordance with one embodiment of the present disclosure.

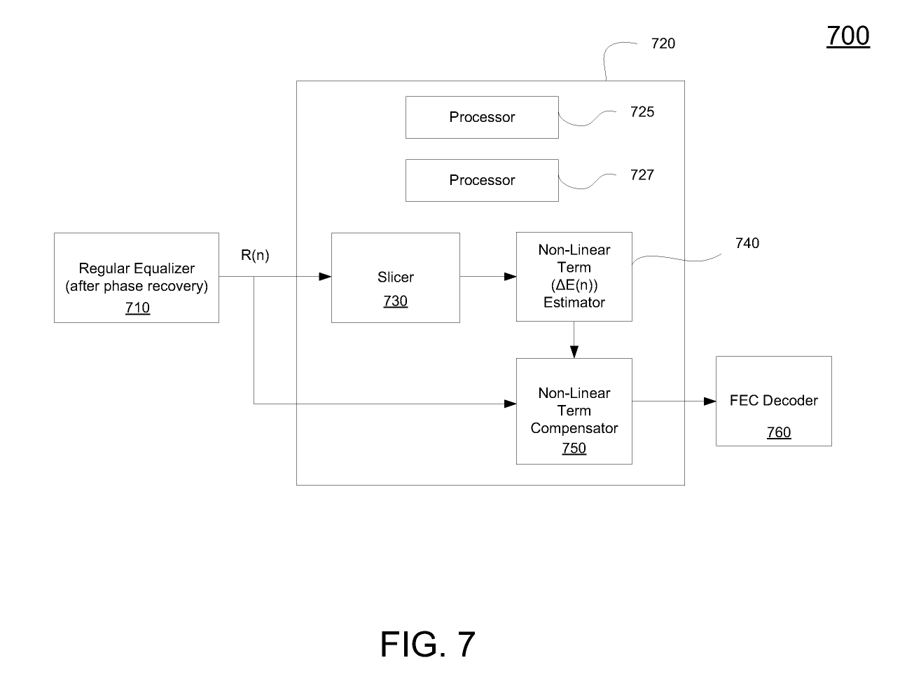

FIG. 7 depicts a receiver configured for reducing link fiber nonlinearities when receiving a signal formatted in QAM, in accordance with one embodiment of the present disclosure.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Accordingly, embodiments of the present invention provide for reducing fiber nonlinearity for coherent optical higher order QAM (e.g., 16QAM) communications by decomposing each QAM symbol into QPSK symbols to avoid the use of complex multiplications.

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer generated step, logic block, process, etc., is here, and generally, conceived to be a self-consistent sequence of steps or instructions leading to a desired result. The steps are those requiring physical manipulations of physical quantities, and refer to the action and processes of a computing system, or the like, including a processor configured to manipulate and transform data represented as physical (electronic) quantities within the computer system's registers and memories into other data similarly represented as physical quantities within the computer system memories or registers or other such information storage, transmission or display devices.

Flowcharts of examples of methods for reducing fiber nonlinearity are provided, according to one or more embodiments of the present invention. Although specific steps are disclosed in the flowcharts, such steps are exemplary. That is, embodiments of the present invention are well-suited to performing various other steps or variations of the steps recited in the flowcharts. Also, embodiments described herein may be discussed in the general context of computer-executable instructions residing on some form of computer-readable storage medium, such as program modules, executed by one or more computers or other devices. By way of example, and not limitation, the software product may be stored in a nonvolatile or non-transitory computer-readable storage media that may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

In digital communications, modulation techniques using higher order QAM modulation rates provide for increased data rates and higher levels of spectral efficiency. However these higher order QAM modulation techniques are susceptible to nonlinear noise and interference. Embodiments of the present invention as described below are configured to reduce fiber nonlinearity for coherent optical QAM communications by avoiding multiplication operations.

In general, the behavior of fiber nonlinearity is dominated by 3^{rd} order distortion, meaning that its mathematical form can be described by the multiplications of any three symbols in the time-domain. The fiber nonlinear model can be described as in Eqn. 1, as follows:

E′(n)−E(n)+Σ_{p,q}C_{pq}E(n+p)E(n+q)E′(n+p+q) (1)

In Eqn. 1, E(n) and E′(n) are symbol-spaced discrete time representations of signals without (e.g., E(n)) and with nonlinear distortions. FIG. 1 is a diagram 100 illustrating the nonlinear terms for E′(n)—such as E(n)—represented by waveform 110, E(n+p) represented by waveform 120, E(n+q) represented by waveform 130, and E(n+p+q) represented by waveform 140, as spread over a time axis 150. Also, C_{pq} represents the nonlinear coefficients that are determined by the fibers used in the link and the signal launch power. Also, p and q are integers accounting for the channel memory, the length of which is scaled with the amount of chromatic dispersion (CD).

Further, in Eqn. 1 and as shown in FIG. 1, each nonlinear term (p, q) requires multiple complex multiplications. Specifically, there are three complex multiplications for each pair of (p, q). The total number of nonlinear terms is determined by the memory length of (p, q), which can be over several hundred symbols for standard single-mode fibers (SSMF), e.g., ˜960 km, which may demand extensive multiplications for the nonlinear terms. These multiplications in fact can be replaced by simple logical operation, if employed with the QPSK format. That is, since each QPSK symbol belongs to the set of {±1, ±j}, where j is the imaginary unit, the products of E(N+p)E(n+q)E′(n+p+q) in Eqn. 1 will still belong to {±1, ±j}. As such, the solution requires only swapping the real and imaginary values, or the inversion of the polarities of the real or imaginary values. This would avoid the use of extensive multiplications, which reduces the implementation complexity.

However, the above technique employed for the QPSK format is unsuitable for use with higher capacity QAM formats (e.g., 16 QAM). That is, since 16 QAM includes more complex symbols, e.g., {±1±j, ±1±3j, ±3±j, ±3±3j}, the products of E(n+p)E(n+q)E′(n+p+q) cannot be obtained by simply swapping the real and imaginary portions or inverting the polarity of the real or imaginary portion, therefore resulting in numerous multiplications for Eqn. 1. To overcome fiber nonlinearities, a new multiplier-free nonlinear compensation to reduce the link fiber nonlinearities for 16 QAM is introduced in embodiments of the present invention. According to one aspect, a multiplier-free compensation method against fiber nonlinearities is provided for higher order coherent optical QAM (e.g., 16 QAM). According to one or more embodiments, this method decomposes each QAM symbol into QPSK symbols to avoid the use of complex multiplications, thus simplifying the implementation.

FIG. 2 is a flow diagram 200 illustrating a method for reducing link fiber nonlinearities, in accordance with one embodiment of the present disclosure. In one embodiment, flow diagram 200 illustrates a computer implemented method for reducing link fiber nonlinearities. In another embodiment, flow diagram 200 is implemented within a computer system including a processor and memory coupled to the processor and having stored therein programmed instructions that, if executed by the computer system causes the system to execute a method for reducing link fiber nonlinearities. In still another embodiment, instructions for performing the method are stored on a non-transitory computer-readable storage medium having computer-executable instructions for causing a computer system to perform a method for reducing link fiber nonlinearities. For instance, the method of flow diagram 200 is implementable within various components of system 500 of FIG. 5, including the transmitter 600 of FIG. 6, and receiver 700 of FIG. 7.

At 210, the method includes decomposing a high order QAM input into a plurality of sub-components. Orders greater than or equal to four for the QAM input (e.g., 4 QAM, 8 QAM, 16 QAM, 32 QAM, 64 QAM, etc.) realize the greatest benefit by reducing execution complexity when determining the compensation for nonlinearity in the QAM input.

At 220, the method includes applying a plurality of logical operations to the plurality of sub-components. In particular, the logical operations do not include a multiplication operation to reduce execution complexity thereby realizing greater speed in execution. For instance, logical operations include AND, OR, NOR, etc., which are implementable within hardware based logic circuits. In one embodiment, the sub-components include QPSK symbols. In another embodiment, the sub-components include 4 QAM symbols.

At 230, the method includes determining a total nonlinear compensation term based on the applying the plurality of logical operations to the plurality of sub-components. In particular, the total nonlinear term is calculated and/or estimated by determining and/or solving the one or more nonlinear terms of the total nonlinear compensation term, wherein each nonlinear term is associated with logical operations. Term selection is dependent on the acceptable execution cost. That is, a more accurate estimation of the total nonlinear compensation term requires execution of more nonlinear terms, whereas a less accurate estimation of the total nonlinear compensation term requires execution of less nonlinear terms. In many cases, accuracy is not sacrificed even though the execution cost is less, as will be described below.

In particular, FIG. 3 depicts diagram 300 illustrating the decomposition of a QAM input signal (e.g., 16 QAM) into two QPSK symbols, in accordance with one embodiment of the present disclosure. For instance, diagram 300 illustrates the decomposition of a higher order QAM input (e.g., 16 QAM) described at 210 of FIG. 2. As shown in FIG. 3, the original QAM signal can be expressed as the sum of two or more QPSK symbols. For instance, a 16 QAM input signal can be expressed in Eqn. 2, as follows:

E(n)=2A(n)+B(n) (2)

As shown in FIG. 3 and Eqn. 2, A(n) and B(n) are independent QPSK symbols belonging to {±1, ±j}. For example, the 16 QAM signal E(n) is represented by constellation diagram 310 having 16 points, and can be broken down into the 2*A(n) term which is represented by constellation diagram 320 having 4 points, and the B(n) term which is represented by constellation diagram 330 having a different 4 points.

As such, the product of the nonlinear term E(n+p)E(n+q)E′(n+p+q) shown in Eqn. 1 can be expanded into the summation of eight products of QPSK. In particular, FIG. 4 is a diagram 400 illustrating the expansion of the nonlinear term E(n+p)E(n+q)E′(n+p+q) 405 into multiple QPSK symbols, in accordance with one embodiment of the present disclosure. For example, the nonlinear term E(n+p)E(n+q)E′(n+p+q) 405 can be approximated as the summation of a first term 410, a second term 420, a third term 430, and a fourth term 440. Each of the terms 410, 420, 430, and 440 can be represented by QPSK terms that are obtained by the execution of simple, logical operations (e.g., without using multiplication).

In this case, the nonlinear term E(n+p)E(n+q)E′(n+p+q) 405 can be obtained by evaluating each QPSK product (e.g., terms 410, 420, 430, and 440) with logical operations. The result is scaled by a factor of the power of 2 (e.g., 1, 2, 4, 8, etc.). In one embodiment, the scaling is performed by shifting the bit (e.g., shifting n bits to the left to multiply by 2″). This result is then summed (e.g., using adders [not shown]).

In one embodiment, since each term 410, 420, 430, and 440 has a different coefficient (e.g., power of two), this means that their impact on the benefit of performing nonlinear compensation would be different. That is, terms having a greater impact on the nonlinear compensation may be kept (e.g., terms with coefficients greater than 4). Also, terms having a lesser impact on the nonlinear compensation may be discarded (e.g., terms with coefficients smaller than 4, such as those terms with 1 and 2). As such, the plurality of sub-components is filtered by discarding at least one term having a smaller coefficient. Of course, the selection of the value of kept coefficients can vary, such that a coefficient of 2 may be kept, or a coefficient of 4 may be discarded, etc. In the case where terms with coefficients of 1 and 2 are determined to have lesser impacts on the determination of the nonlinearity compensation, terms in block 490 may be discarded, such as terms 430 and 440. In this manner, the complexity of determining the nonlinear term and its compensation can be reduced as much as, and even greater than, fifty percent for each product.

In an extreme case where only the first sub term of the nonlinear term E(n+p)E(n+q)E′(n+p+q) 405 remains, the process may turn to a “degenerate” method, which immediately degenerates each 16 QAM symbol to a single QPSK at the expense of a certain amount of inaccuracy.

In another embodiment, the QAM decomposition method depicted in FIGS. 2-4 can also be applied for higher orders of QAM. For instance, in the case of the higher order 64 QAM, each 64 QAM input can be expressed as the sum of three QPSK symbols: E(n)=4A(n)+2B(n)+C(n).

FIG. 5 depicts a system 500 configured for reducing link fiber nonlinearities, in accordance with one embodiment of the present disclosure. In particular, system 500 includes a communication network 550 (e.g., an optical network), a plurality of transmitters 600 electronically coupled to the network 550, and a plurality of receivers 700 electronically coupled to the network 550. In that manner, a particular transmitter 600 is able to communicate with a particular receiver 700, such that a signal is transmitted and received using QAM (e.g., 16 QAM). At either or both the transmitter 600 and receiver 700, a process for reducing link fiber nonlinearities can be performed. That is, either or both transmitter and receiver 700 are configurable for performing the methods outlined in FIG. 2-4, in embodiments.

In particular, both transmitter 600 and receiver 700 are each capable of decomposing a high order QAM input into a plurality of sub-components, applying a plurality of logical operations to the plurality of sub-components, and determining a non-linear compensation term based on the application of a plurality of logical operations to the plurality of sub-components, which were decomposed from the input signal. For instance, these operations can be performed within the digital signal processor (DSP) based transceivers located within system 500.

FIG. 6 depicts a transmitter 600 configured for reducing link fiber nonlinearities, in accordance with one embodiment of the present disclosure. For example, transmitter 600 may be implemented within system 500 of FIG. 5. In addition, transmitter 600 is configurable for performing the methods outlined in FIGS. 2-4, in embodiments of the present invention.

As shown in FIG. 6, transmitter 600 may include a processor 625 and memory 627, wherein the processor 625 is configured to execute computer-executable instructions stored in the memory 627. Further, the processor 625 may be included within a single or multi-processor computing device or system capable of executing computer-readable instructions. In its most basic form, a computing device may include at least one processor and a system memory. System memory 627 is coupled to processor 625, and generally represents any type or form of volatile or non-volatile storage device or medium capable of storing data and/or other computer-readable instructions. Examples of system memory include, without limitation, random access memory (RAM), read only memory (ROM), Flash memory, or any other suitable memory device.

Processor 625 and memory 627 may be included within block 620 specifically configured for reducing link fiber nonlinearities. For example, block 620 is inserted between the signal source E(n) 610 and the digital-to-analog converter (DAC) 660. More specifically, block 620 reduces and/or compensates for link fiber nonlinearities by first determining the nonlinearity term ΔE(n) at calculator 630, and then subtracting the nonlinearity term from the input signal E(n). The filtered term is received by a pre-equalizer 650 that may be located between block 620 and the DAC 660. After conversion, the signal is modulated by modulator 670 and transmitted over the network.

FIG. 7 depicts a receiver configured for reducing link fiber nonlinearities, in accordance with one embodiment of the present disclosure. For example, receiver 700 may be implemented within system 500 of FIG. 5. In addition, receiver 700 is configurable for performing the methods outlined in FIGS. 2-4, in embodiments of the present invention.

As shown in FIG. 7, receiver 700 may include a processor 725 and memory 727, wherein the processor 725 is configured to execute computer-executable instructions stored in the memory 727. Further, the processor 725 may be included within a single or multi-processor computing device or system capable of executing computer-readable instructions. In its most basic form, a computing device may include at least one processor and a system memory. System memory 727 is coupled to processor 725, and generally represents any type or form of volatile or non-volatile storage device or medium capable of storing data and/or other computer-readable instructions. Examples of system memory include, without limitation, random access memory (RAM), read only memory (ROM), Flash memory, or any other suitable memory device.

Processor 725 and memory 727 may be included within block 720 specifically configured for reducing link fiber nonlinearities. For example, block 720 may be located right after the regular equalizer 710 that receives the signal after phase recovery, and outputs the equalized signal R(n). A slicer 730 receives the equalized signal R(n) and is configured for mitigating the noise impact, and more importantly, to ensure that all the symbols are received to the original symbol positions so that QAM decomposition and logical operations can be employed for nonlinearity compensation.

After slicer 730, the nonlinear term ΔE(n) is determined by estimator 740. Thereafter, the nonlinear term compensator 750 subtracts the nonlinear term ΔE(n) from the equalized signal R(n).

Thus, according to embodiments of the present disclosure, systems and methods are described for reducing link fiber nonlinearities in optical networks.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

Although the present invention and its advantages have been described in detail, it should be understood that various changes, substitutions, and alterations can be made herein without departing from the spirit and scope of the invention as defined by the appended claims. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Embodiments according to the present disclosure are thus described. While the present disclosure has been described in particular embodiments, it should be appreciated that the disclosure should not be construed as limited by such embodiments, but rather construed according to the below claims.

1. An apparatus for reducing link fiber nonlinearities, comprising:
a memory device comprising programmed instructions;
a processor communicatively coupled to the memory device and configured to execute the programmed instructions to receive a high order quadrature amplitude modulation (QAM) input from a source, to decompose the input into a plurality of sub-components, and to apply a plurality of logical operations to said plurality of sub-components; and
a non-linear term calculator coupled to the processor and configured to determine a non-linear compensation term based on said plurality of logical operations applied to said plurality of sub-components.

2. The apparatus of claim 1, wherein an order of said high order QAM is greater than 4.

3. The apparatus of claim 1, wherein said plurality of sub-components comprises a plurality of quadrature-phase-shift-keying (QPSK) symbols.

4. The apparatus of claim 1, wherein said plurality of sub-components comprises a plurality of 4 QAM symbols.

5. The apparatus of claim 1 further comprising a transmitter comprising said processor to perform pre-distortion.

6. The apparatus of claim 1, further comprising a receiver comprising said processor to perform post-compensation.

7. A method for reducing link fiber nonlinearities executed by a processor, comprising:
decomposing a high order quadrature amplitude modulation (QAM) input into a plurality of sub-components;
applying a plurality of logical operations to said plurality of sub-components; and
determining a non-linear compensation term based on the applying said plurality of logical operations to said plurality of sub-components.

8. The method of claim 7, wherein said plurality of logical operations does not include multiplication.

9. The method of claim 7, wherein an order of said high order QAM input is greater than 4.

10. The method of claim 7, wherein said plurality of sub-components comprises a plurality of quadrature-phase-shift-keying (QPSK) symbols.

11. The method of claim 7, wherein said plurality of sub-components comprises a plurality of 4 QAM symbols.

12. The method of claim 7, further comprising:
implementing said decomposing, said applying, and said determining to perform pre-distortion at a transmitter.

13. The method of claim 7, further comprising:
implementing said decomposing, said applying, and said determining to perform post-compensation.

14. The method of claim 7, further comprising:
filtering said plurality of sub-components by discarding a term with a smaller coefficient.

15. The method of claim 7, further comprising:
subtracting said non-linear compensation term from said high order QAM at a transmitter.

16. The method of claim 7, further comprising:
subtracting said non-linear compensation term from an equalized signal R(n) at a receiver.

17. A system comprising:
a plurality of transmitters; and
a plurality of receivers coupled to said plurality of transmitters;
wherein at least one of a transmitter or a receiver is configured for reducing link fiber nonlinearities by decomposing a high order quadrature amplitude modulation (QAM) input into a plurality of sub-components, applying a plurality of logical operations to said plurality of sub-components, and determining a non-linear compensation term based on said applying the plurality of logical operations to said plurality of sub-components.

18. The system of claim 17, wherein said plurality of transmitters and said plurality of receivers are comprised in an optical network.

19. The system of claim 17, wherein said plurality of sub-components comprises a plurality of quadrature-phase-shift-keying (QPSK) symbols or a plurality of 4QAM symbols.

20. The system of claim 17, wherein an order of the high order QAM input is greater than 4.
